(19) United States
(12) Patent Application Publication
(10) Pub. No.: US 2026/0210808 A1
(43) Pub. Date: Jul. 23, 2026

(54) METHOD FOR MEASURING TREAD WEAR OF A TRACK

(71) Applicant: COMPAGNIE GENERALE DES ETABLISSEMENTS MICHELIN, Clermont-Ferrand (FR)

(72) Inventor: Adrian ALBOTA, Clermont-Ferrand (FR)

(21) Appl. No.: 19/140,245

(22) PCT Filed: Dec. 18, 2023
(86) PCT No.: PCT/EP2023/086294

§ 371 Date: Jun. 17, 2025

(30) Foreign Application Priority Data
Dec. 19, 2022 (FR) FR2213805

(51) Int. Cl. G01M 17/03; G01B 11/22

(52) U.S. Cl. CPC G01M 17/03; G01B 11/22

(57) ABSTRACT

A method of measuring a track is provided that has a code spaced from a worn tread surface in a thickness direction. Visual data is obtained from the track and the code, and from this visual data a length of the code is determined. The code is located between the worn tread surface and a point, and a length of a position of the code extends from the point to the code. A worn tread surface to code length is determined using the visual data. A worn thickness is calculated by adding the length of the position of the code to the worn tread surface to code length.

### FIELD OF THE INVENTION

The subject matter of the present invention relates to a method of measuring tread wear of a track through the use of a code to determine whether the tread of the track is in such a worn state that it should be replaced. More particularly, the present application involves a tread wear measurement that utilizes a barcode or a two-dimensional code located on the track and a visual data capture device to capture visual data to ascertain the amount of remaining tread on the track.

### BACKGROUND OF THE INVENTION

Tracks are used on agricultural vehicles, construction vehicles, military vehicles, forestry vehicles, snowmobiles, and all-terrain vehicles. Tracks enhance traction of these vehicles on soft, slippery, and irregular ground on which these vehicles traverse. The vehicle that employs tracks uses a track-engaging assembly with an endless rubber track disposed thereon that engages the ground. The track-engaging assembly has a frame, tensioner, and a plurality of wheels around which the endless track is disposed. The track-engaging assembly can drive the track via a friction drive arrangement. Here, the track is held tightly enough against wheels of the track-engaging assembly such that rotation of one of the wheels pulls the track by a frictional engagement around the track-engaging assembly. Alternatively, the track can include drive lugs on an inner surface that engage a drive wheel of the track-engaging assembly such that rotation of the drive wheel is transferred to the track to cause it to rotate around the track-engaging assembly.

The track is made of a carcass, that can include belts, and a tread that extends from the carcass and is located on an outer surface of the track. Through normal use, the tread on tracks becomes worn which necessitates replacement or retreading of the track. In this regard, the entire track can be removed from the track-engaging assembly and replaced with a new track, or after removal the remaining tread can be ground off and replaced with new tread on the previously used carcass. The removal and replacement of the track on a track-engaging assembly is a labor and time heavy process, and it would be useful if one were able to plan for this work. As such, a mechanism of measuring the wear on tracks to determine if it needs replacement, or alternatively measuring the wear on tracks to determine how much tread life remains would be helpful.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an agricultural vehicle that has a track on a track-engaging assembly in accordance with one embodiment.

FIG. 2 is a perspective view of a portion of a track that shows a side of the track with a code thereon.

FIG. 3 is a schematic view of the side of a track that has a barcode and a track-engaging assembly and a cell phone that captures an image for analysis.

FIG. 4 is a schematic view of a section of a track and drive wheel of a track-engaging assembly and an imaging device for a method that measures to an outward point of a barcode of the track.

FIG. 5 is a schematic view of the side of the track that has a QR code and a track-engaging assembly and a cell phone that captures an image for analysis.

FIG. 6 is a schematic view of the side of a track and a cell phone that captures an image of the track for analysis in which the code is a QG code.

FIG. 7 is a front view of a barcode.

FIG. 8 is a front view of a barcode that has a position line.

FIG. 9 is a front view of a barcode that is a Code 128.

FIG. 10 is a front view of a barcode that is an interleaved 2 of 5 barcode.

FIG. 11 is a front view of a barcode that is a Code 93.

FIG. 12 is a front view of a barcode that is a two-track pharmacode.

FIG. 13 is a front view of a barcode that uses flattermarken marks.

FIG. 14 is a front view of a barcode that is circular in shape.

FIG. 15 is a front view of a two-dimensional code that is a data matrix.

FIG. 16 is a front view of a two-dimensional code that is a PDF417.

FIG. 17 is a front view of a two-dimensional code that is an Aztec code.

FIG. 18 is a front view of a two-dimensional code that is a MaxiCode.

FIG. 19 is a front view of a two-dimensional code that is a QR code.

FIG. 20 is a front view of a cell phone that displays a replacement message.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention and is not meant as a limitation of the invention. For example, features illustrated or described as part of one embodiment can be used with another embodiment to yield still a third embodiment. It is intended that the present invention include these and other modifications and variations.

A method of measuring wear on a track 10 is provided that involves capturing visual data from the track 10 through the use of an imaging device that may be a cell phone 40, lidar scanner 42, or other imaging device in accordance with various embodiments. A code 12 is located on the track 10, and the visual data captured includes a reading of the code 12 and use of a length 16 of the code 12 to in turn ascertain data on the worn tread surface 14 of the track 10. The wear of the track 10 can then be calculated by using this data that was visually captured. A message 54 to the user of the method can be sent to indicate to him or her the amount of tread 72 remaining on the track 10, or to indicate that it is time to replace the track 10 if the tread 72 has reached its end of life.

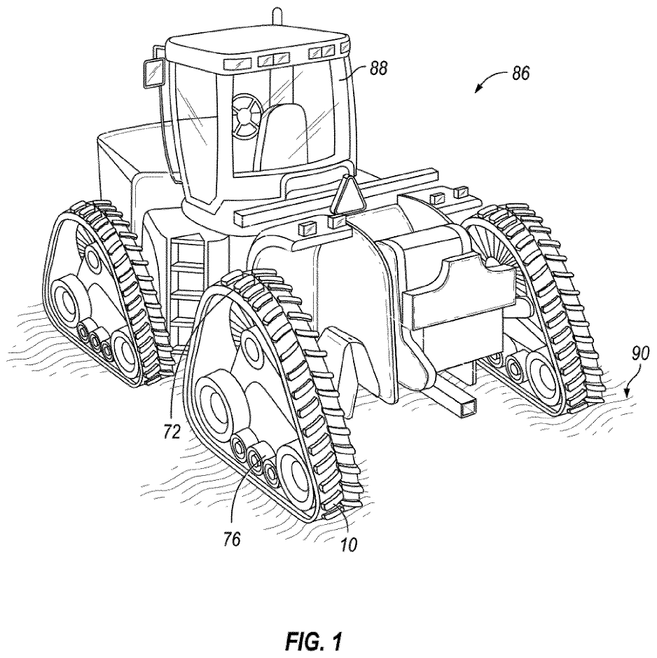

FIG. 1 is a perspective view that shows the track 10 disposed on a track-engaging assembly 76 that tensions the track 10 and drives the track 10 so that the agricultural tractor vehicle 86 in turn is driven along the ground 90. Although four track-engaging assemblies 76 and four tracks 10 are shown, in other embodiments tires can likewise be used on the agricultural tractor vehicle 86 such that only two track-engaging assemblies 76 and two tracks 10 are present on the vehicle. The tracks 10 engage the ground 90 such that an outer surface 68 of the tracks 10 that include tread 72 engage the ground 90. The agricultural tractor vehicle 86 has a cab 88 into which an operator may be located, and a trailer can be hauled behind the agricultural tractor vehicle 86 that may or may not likewise include tracks 10 with track-engaging assemblies 76. The vehicles onto which the track 10 and the track-engaging assembly 76 can be utilized can be of various types. For example, when provided as an agricultural vehicle, the vehicle may be a tractor, combine, or harvester. When the vehicle is a military vehicle, it may be an armored personnel carrier or an infantry fighting vehicle. When provided as a constructure vehicle, the vehicle can be a mini-excavator or a small loader. If the vehicle is a forestry vehicle, it may be a feller-buncher, tree chipper, or a knuckleboom loader. The vehicle could also be a snowmobile or all-terrain vehicle. It is to be understood that the track 10 utilized with the present method may be on any number of different types of vehicles.

FIG. 2 is a perspective view of a portion of a track 10 that includes a code 12 that in this instance is a barcode. The track 10 is made of a carcass 66 that can be constructed of rubber with belts disposed therein that add strength and structure to the carcass 66. The belts may be made of steel, nylon, or other material distinct from the rubber of the carcass 66. The tread 72 is located on an outer surface 68 of the track 10 and extends from the carcass 66 in a thickness direction 46 of the track 10. The tread 72 has an outer, upward surface that is a worn tread surface 14. As the tread 72 wears, the worn tread surface 14 wears away in the thickness direction 46 such that the worn tread surface 14 moves closer and closer to the carcass 66 as more and more wear occurs. The tread 72 is made of rubber and can be configured in a variety of manners.

The thickness direction 46 of the tread 72 is oriented at a 90 degree angle to a longitudinal direction 48 of the tread 72. The track 10 can extend 360 degrees in the longitudinal direction 48 in that it extends all the way around the track-engaging assembly 76 to contact itself on an opposite end such that the track 10 does not have an end. Opposite from the outer surface 68 is an inner surface 70 that includes drive lugs 84. The drive lugs 84 extend from a side of the carcass 66 opposite from that which the tread 72 extends. The drive lugs 84 may engage the drive wheel 94 of the track-engaging assembly 76 in a direct drive engagement so that the track 10 can be driven around the track-engaging assembly 76. The drive lugs 84 are not portions of the track 10 that are measured by the present method, and need not be present in the track 10 in other embodiments. The carcass 66 has a side 78 that could be a terminal side of the carcass 66 in a lateral direction that is perpendicular to both the longitudinal direction 48 and the thickness direction 46. A code 12, in this instance a barcode 12, is located on the side 78. The code 12 is spaced from a bottom of the carcass 66 in the thickness direction 46 and is spaced from and not in engagement with the tread 72 in the thickness direction 46. The code 12 can be affixed to the carcass 66 in a variety of manners such as being adhered thereon with an adhesive, embossed thereon, etched thereon, or applied in any other manner.

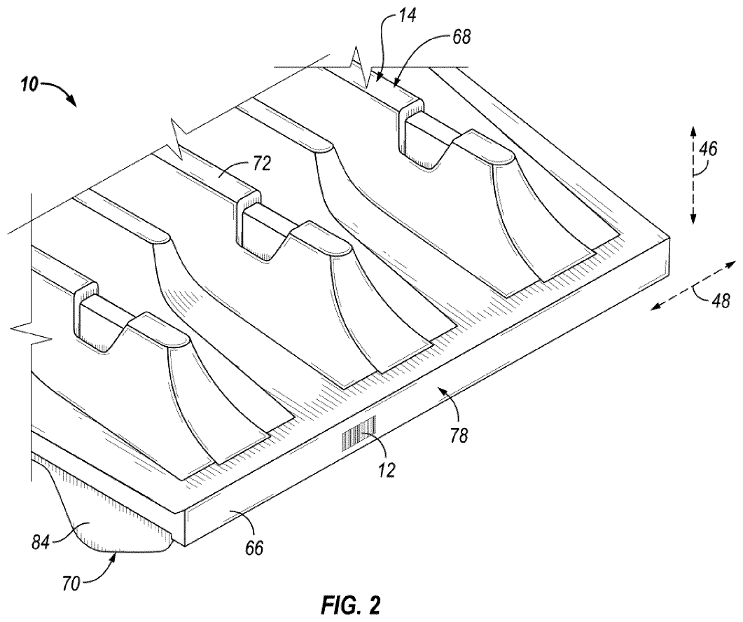

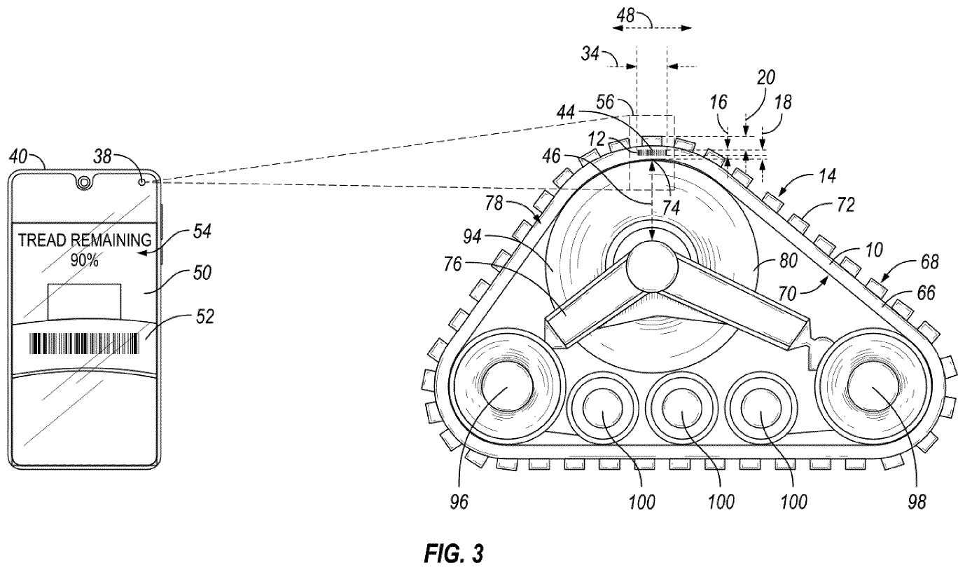

FIG. 3 is a schematic view of a track 10 that is in side view and is being imaged by an image capture device that is in this case a cell phone 40. The track 10 is located on a track-engaging assembly 76 that supports the track 10 and drives it around an axis to in turn cause the vehicle to which it is attached to move. The thickness direction 46 and longitudinal direction 48 are relative in FIG. 3 and depend upon the exact portion of the track 10 being discussed. The track-engaging assembly 76 includes a plurality of wheels 80 that may all engage the inner surface 70 of the track 10 as it rotates around the track-engaging assembly 76. A drive wheel 94 is in rotational communication with an axis of the vehicle 86 such that the vehicle 86 causes rotation of the drive wheel 94 which in turn engages the track 10 and causes the track 10 to move. The track 10 extends around a front idler wheel 96 and a rear idler wheel 98 and these idler wheels 96, 98 are not driven wheels. Three mid-rollers 100 engage the track 10 between the idler wheels 96, 98 and push the track 10 onto the ground 90. Like the idler wheels 96, 98, the mid-rollers 100 themselves are not drive wheels but instead rotate based upon engagement with the inner surface 70 such that movement of the track 10 causes the wheels and rollers 96, 98, 100 to rotate. Although shown with six wheels/rollers 94, 96, 98, 100, any number of wheels/rollers and configurations are possible with the track-engaging assembly 76 in accordance with other exemplary embodiments.

The tread 72 has at its outward most position in the thickness direction 46 a worn tread surface 14 that engages the ground 90. The tread 72 can be disposed in the thickness direction 46 above sides 78 of the tread 72 that are on lateral sides of the track 10 in the lateral direction, and the tread 72 extends some distance from the worn tread surface 14 in the thickness direction 46. Although described as being sides 78 of the carcass 66, the sides 78 could be the sides of the tread 72 in other embodiments. The sides 78 may be made of the same material as the rest of the tread 72, or may be made of different material. The sides 78 can thus be sides of the tread 72 or sides of the carcass 66.

When originally purchased and installed on a vehicle 86, the tread 72 has a new tread surface that is further outward in the thickness direction 46 from the carcass 66 than the worn tread surface 14, but through wear of the track 10 this new tread surface wears down to the illustrated worn tread surface 14. A code 12, that in this case is a barcode 12, is located on the side 78 of the carcass 66. The code 12 is spaced in the thickness direction 46 from the worn tread surface 14 such that no portion of the worn tread surface 14 engages the code 12. A replacement surface of the tread 72 is located farther from the code 12 in the thickness direction 46 than is the worn tread surface 14 to the code 12 in the thickness direction 46. The code 12 can be located relative to a replacement surface of the tread 72 in the thickness direction 46 such that the replacement surface is reached without any wear or removal of the code 12.

A user of the system will use the cell phone 40 to take an image 52 of the track 10 with the cell phone camera 38. The view 56 should be a portion of the track 10 that includes both the tread 72 and the code 12. The entire tread 72 of the track 10 does not need to be captured in the view 56, but at least some of it should be captured along with the code 12. A portion of the drive wheel 94 is captured in the image 52, but need not be in other embodiments. Preferably, both the tread 72 and the code 12 are both captured in the same view 56, but other methods are possible in which multiple images 52 are captured such that the tread 72 is in one image 52 with the code 12 in a different image 52. The code 12, in this instance a barcode 12, is oriented on the track 10 such that it extends longer in the longitudinal direction 48 than it extends in the thickness direction 46. The code 12 has a longitudinal length 34 that is longer than a length 16 that extends in the thickness direction 46. The longitudinal length 34 is longer in the longitudinal direction 48 than the thickness direction 46, and is a straight length as shown in FIG. 3 as the barcode 12 has a rectangular shape. The length 16 could be described as the height of the code 12, and is longer in the thickness direction 46 than in the longitudinal direction 48. The lengths 34, 16 simply represent the width and height of the code 12. A single view 56 may capture the entire longitudinal length 34 and length 16 of the code 12 along with a side view of some of the tread 72 of the track 10 and along with some of the side 78 of the track 10 that is between the tread 72 and the code 12.

The code 12 can be provided on the track 10 in any number of manners. The code 12 could be molded into the side 78 during the curing process. The code 12 could also be applied to the track 10 by being a sticker that is placed onto the track 10 either before or after the curing process. Laser printing, or any other type of printing, could also be used to apply the code 12 to the track 10. The code 12 may provide information about the track 10 type, may provide specific dimensional information about the track 10, or may provide both.

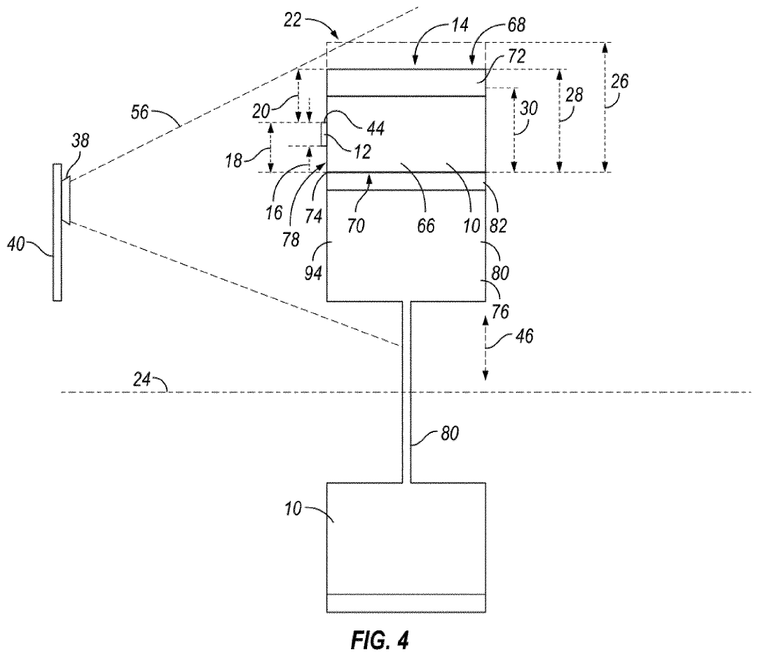

The image 52 that is generated on the display 50 of the cell phone 40 may be that as captured in the view 56 directed onto the track 10. Also displayed is a message 54 that indicates the amount of tread 72 left on the track 10 as output by analysis of the tread 72 and known values. Turning to FIG. 4, an exemplary embodiment of the method of evaluating the track 10 can be described. The portion of the track 10 shown is a portion that engages the drive wheel 94. In this regard, the drive wheel 94 rotates about a central axis 24 and has wheel tread 82 located at its outer periphery that engages the inner surface 70 of the track 10. The wheel tread 82 may be made out of rubber in some embodiments. When new, the track 10 is at 100% remaining tread life and no wear has occurred. The new tread surface 22 is illustrated in FIG. 4, and the new thickness 26 is also noted and is the length in the thickness direction 46 from point 74 to the new tread surface 22. Point 74 is a point on the track 10 from which various thicknesses 26, 28, 30 are measured. Point 74 is located at a distance in the thickness direction 46 such that the code 12 is located between the new tread surface 22, worn tread surface 14, and the replacement read surface and the point 74. In the disclosed embodiment the point 74 is on the carcass 66 at a location of the carcass 66 that is farthest from the worn tread surface 14 in the thickness direction 46. In some embodiments, the point 74 may be on the carcass 66 at a location in engagement with the drive wheel 94.

Upon wear of the tread 72, the tread 72 will shrink in size in the thickness direction 46 so that the worn tread surface 14 establishes a worn thickness 28 which is less than the new thickness 26. The worn thickness 28 is the distance in the thickness direction 46 from the point 74 to the worn tread surface 14. A replacement thickness 30 is also shown in FIG. 4 which is smaller than both the worn thickness 28 and the new thickness 26. The replacement thickness 30 is the thickness at which time the tread 72 is considered worn to such a degree that replacement should be made. The track 10 could be thrown away and replaced, or the track 10 in some instances could be retreaded once the track 10 reaches a thickness of the replacement thickness 30.

The image capturing device in FIG. 4 is a cell phone 40 that has a cell phone camera 38, and the user may capture the image of a view 56 of a portion of the track 10. The view 56 need not be the entire track 10, but could be in some embodiments. In the FIG. 4 embodiment the view 56 includes the side of the track 10 and captures the code 12, that again in this embodiment is a barcode 12, and the side of the worn tread surface 14. A portion of the drive wheel 94 that engages the track 10 at the area of the image capture is likewise included. The cell phone 40 should be held a sufficient distance from the track 10 to capture the relevant objects, and should be held at a parallel orientation to the code 12 so that the cell phone camera 38 has a straight on as possible view of the track 10. The method for measuring could provide additional information to the user and visual guidance on the cell phone 40 about the positioning of the cell phone 40 such as a frame that helps centering the barcode 12 in the image 52. Software in the cell phone 40 or on a server could provide this additional information or centering frame. The view 56 does not include the central axis 24 of the drive wheel 94, but the middle/central axis 24 could be within the view 56 in other embodiments.

The cell phone 40 includes the cell phone camera 38 and an internal operating system that allows an application to run on it to process information the cell phone camera 38 captures and access a database with dimensional information on it to determine the wear of the track 10. The database may be external to the cell phone 40 or included on the cell phone 40. Although described as being a cell phone 40, any other type of device or devices can be used to capture the image 52, perform a database look up, and process the data to obtain the wear rate.

The image 52 captures the code 12 and a processor reads the code 12 and can identify the type of track 10 through this code 12. A database can be consulted so that the processor or user can know the dimensions of the new thickness 26 and replacement thickness 30. Additionally, since the particular track 10 can be identified via the code 12, the system may also know what the length 16 of the code 12 is and may know exactly where on the track 10 the code 12 was positioned which is identified in FIG. 4 as the length 18 of the position of the code 12. The code 12 has a known position on the track 10 and a known size. The length 16 is measured in the thickness direction 46 and is thus the length of the barcode 12 as measured in the thickness direction 46. The length 18 is likewise measured in the thickness direction 46 and is the distance from the point 74 to a most position 44 of the code 12 that is closest to the outer surface 68 in the thickness direction 46. The lengths 16, 18 may thus be known distances that are established at the time the track 10 is manufactured and the barcode 12 is put onto the track 10 or formed with the track 10. The lengths 16, 18 may be obtained via lookup in a database by the user or by a processor.

The position 44 is a part of the code 12 closest to the outer surface 68. This position 44 can be the very end of one of the bar portions of the barcode 12, or could be a point located on the end of a label of the barcode 12 and not necessarily a point on one of the bars of the barcode 12. The position 44 can be used to ascertain the location of the code 12 on the track 10 in some embodiments, but need not be used in other embodiments.

The lengths 26, 30, 16 and 18 may thus all be known lengths that are established before any wear on the track 10 occurs. These lengths 26, 30, 16, 18 can be stored in a database on the cell phone 40 or remotely such as on the cloud or other server for access by the processor or user. The processing can be an application running on the cell phone 40 and may utilize a database with known information also on the cell phone 40 or on the cloud. The system may know the lengths 26, 30, 16, 18 before the visual data is captured by the cell phone 40. The image 52 that is captured in the view 56 will capture the entire length 16 of the code 12, and will capture the tread 72 to the extent that the side of the tread 72 at the worn tread surface 14 will be captured in the image 52. The length 20 in FIG. 4 represents the length in the thickness direction 46 from the code 12 to the worn tread surface 14.

The processor will know the length 16 via database look up and can then compare this known length 16 to the same thickness length 16 taken in the image 52 to calibrate itself. With this calibration, the length 20 in the image 52 can be ascertained. The calibration to determine the length 20 may be achieved by knowing the number of pixels present in the known thickness length 16 and comparing this to the measured amount of pixels in the image 52 of the thickness length 16, and then comparing this information to the measured length 20 in the image 52. In other embodiments, color differences between what is known and what is measured can be used to calibrate the method to determine the length 20. The processor uses the measured distance in the thickness direction 46 between the worn tread surface 14 and the position 44 of the code 12, and the measured length 16 along with the known length 16 from the database to obtain the correct length 20 in the thickness direction 46 from the position 44 of the code 12 to the worn tread surface 14. The visual data thus includes the entire lengths 16 and 20, along with the bars of the barcode 12 sufficient to read the barcode 12. The entire barcode 12 can be captured in the image 52 when executing the method. The code 12 itself is located on the carcass 66 only and not on the tread 72. In other embodiments, the code 12 may be located completely on the tread 72 with no portions on the carcass 66, and in yet other embodiments the code 12 could be positioned on the track 10 so that it is located on both the tread 72 and the carcass 66.

With this information, the system may then determine the worn thickness 28. The method may add together length 18 of the position of the code 12 to the length 20 of worn tread surface 14 to the barcode 12 to arrive at the worn thickness 28. It is to be understood that the new thickness 26, worn thickness 28, and replacement thickness 30 are measured between points remote from the central axis 24 in the thickness direction 46 and are not based off of the position of the central axis 24 and do not express the diameter of the track 10. The point 74 could be located at the position of the track 10 that is farthest from the outer surface 68, or could be at a position of the track 10 that is not the farthest from the outer surface 68 in the thickness direction 46.

With the measured information, the method may calculate the track wear rate. A processor could make this track wear rate calculation. The processor as described in the present application may be in the cell phone 40, in the cloud, a remote server, or in any combination of these components. The track wear rate equals ((new thickness 26−worn thickness 28)/(new thickness 26−replacement thickness 30)). Additional data analysis may be executed by the processor in that if the previously calculated worn thickness 28 is greater than the replacement thickness 30 then a track okay message 54 is displayed. In such instances if the track wear rate was calculated by the processor, this track wear rate may be additionally displayed with the okay message 54. If the worn thickness 28 is less than the replacement thickness 30, the processor may make this determination and then issue a warning message 54 to the user to tell him or her that the track 10 needs to be changed. A negative wear rate could be calculated to let the user know how far below replacement the tread 72 has reached. Measured data combined with date and location information provided by the device and software may be processed under the form of track 10 tread wear speed in time per specific location of wear.

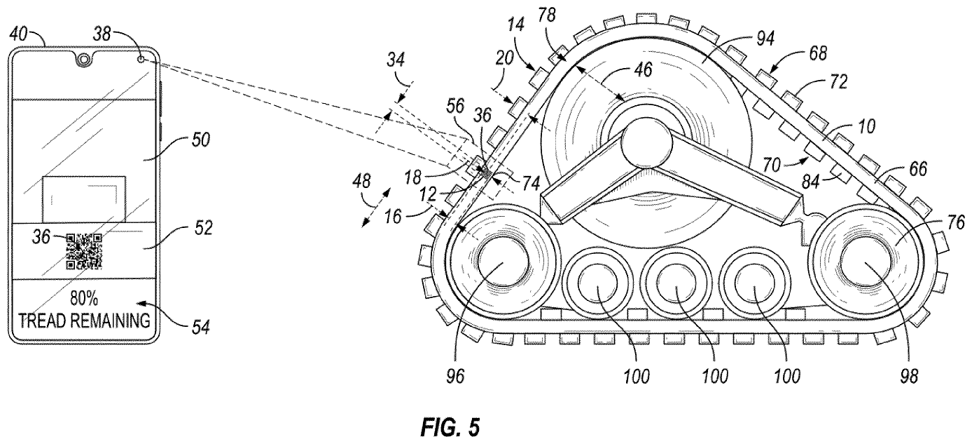

Another embodiment of the method is shown with reference to FIG. 5. The same methods as previously described with respect to the FIG. 4 embodiment can be executed with the FIG. 5 embodiment with the following exceptions. The code 12 is a two-dimensional code 12 instead of a barcode 12 in FIG. 5 and has a length 16 that extends in the thickness direction 46, and has a position 44. However, the two-dimensional code 12 in FIG. 5 has a position line 36 that is located at a particular position in the thickness direction 46. The length 18 of the position of the two-dimensional code 12 is not measured from the point 74 to the position 44 of the two-dimensional code 12, but instead the length 18 of the position of the two-dimensional code 12 is measured from the point 74 to the position line 36. Length 18 is thus not measured from the point 74 to the position 44, but is instead measured from the point 74 to the position line 36, which can be at any thickness position of the two-dimensional code 12. The length 20 from the worn tread surface 14 to the two-dimensional code 12 is measured in the thickness direction 46 that is from the position line 36 to the worn tread surface 14. It is thus the case that unlike the FIG. 4 embodiment, the length 20 is not from the position 44 to the worn tread surface 14, but is instead from the position line 36 to the worn tread surface 14.

The image 52 that is captured need not include any of the wheels 80, frame, tensioner, or other components of the track-engaging assembly 76. The image 52 need only capture the code 12 and tread 72 of the track 10 in order to execute the method. The code 12 and tread 72 can be captured at any orientation along the track-engaging assembly 76 and need not be oriented in a straight, vertical position. In this regard, the cell phone 40 can turn or otherwise manipulate the image 52 on the display 50, or in some instances may leave the tread 72 and code 12 in the same orientation as they are in real time. The method can function regardless of the orientation of the tread 72 and code 12 with respect to the ground 90.

When the method obtains the visual data, the data about the track 10 that the method then ascertains can be data from a look-up table and/or data observed in the view 56. The data about the track 10 may be the length 18 of the position of the code 12, the length 16 either observed and/or taken from a look-up table, the new thickness 26, a replacement thickness 30, the longitudinal length 34, track 10 type, information about the two-dimensional code 12, and other data. The entire code 12 is located inward in the thickness direction 46 from the outer extent of the replacement thickness 30 such that the code 12 can still be read once the tread 72 reaches its end of life.

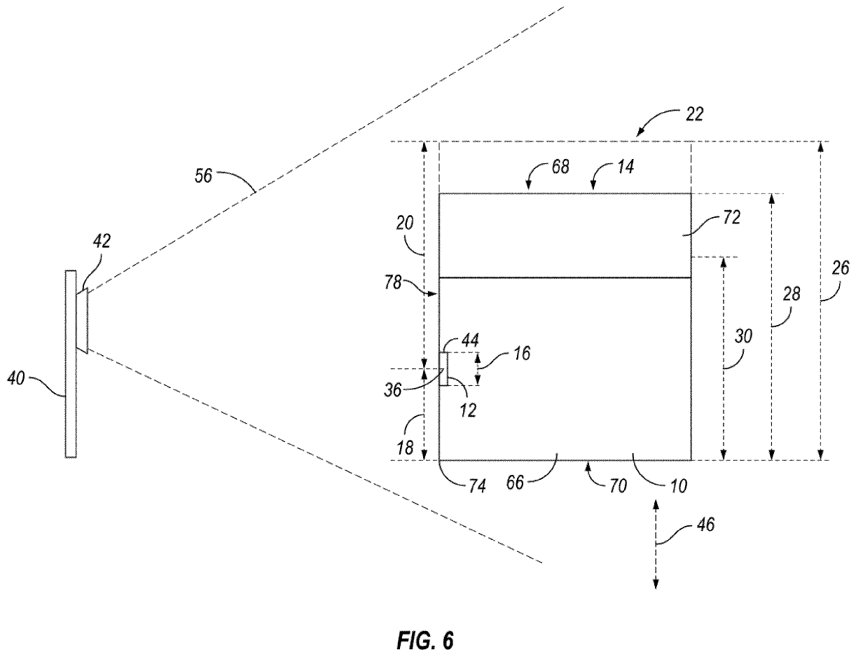

FIG. 6 shows another alternative embodiment of the method in which the code 12 is a two-dimensional code 12 that features a position line 36 as previously discussed. The view 56 captures only the track 10 and no other portion of the track-engaging assembly 76 and the method can be executed without the need for image capture of any of the parts of the track-engaging assembly 76. The method of FIG. 6 would again have as a known item the new thickness 26, the replacement thickness 30, the length 16, and the length 18. The visual data obtained from the view 56 will capture the code 12 so that the aforementioned known elements can be looked up from a database, and so that the measured length 16 can be known and compared to the length 16 from the database for calibration purposes. The length 20 can be measured as previously discussed, only this length 20 will be from the worn tread surface 14 to the position line 36. The worn thickness 28 may be calculated as previously discussed by adding the lengths 18 and 20 together. The other data analysis steps such as the calculation of wear rate percentage, messages 54 displaying the track 10 tread is acceptable, messages 54 displaying the tread 72 needs replaced, and the negative wear rate percentage may be calculated and displayed as previously discussed.

Instead of a cell phone camera 38, the cell phone 40 in FIG. 6 uses a lidar scan 42 to obtain the image 52 from the view 56. In other embodiments, a laser scan can be used to obtain the image 52. It is thus the case that the image 52 obtained from the track 10 and code 12 can be obtained through any number of different visual data capture devices that could be employed in various embodiments of the present method.

The position 44 of the two-dimensional code 12 is a point of the two-dimensional code 12 closest to the worn tread surface 14 in the thickness direction 46, and consequently farthest from the bottom most point of the carcass 66. This position 44 can be the very end of one of the data points of the two-dimensional code 12, or could be a point located on the end of a label of the two-dimensional code 12 and not a data point on the two-dimensional code 12. The point 74 is located at the same location in the thickness direction 46 as would be engagement with the inner surface 70 with one of the wheels 80. Point 74 need not be at the bottom of the carcass 66 in other embodiments, but could be a location spaced from the bottom of the carcass 66 in the thickness direction 46. In some embodiments, the point 74 is located at the same position in the thickness direction 46 as a portion of the code 12 such that the length 18 is relatively small. In FIG. 6, the entire code 12 is spaced from the point 74 such that some of the carcass 66 is located on either side of the code 12 in the thickness direction 46. The code 12 in other embodiments can be located on just the carcass 66, just the tread 72, or on both the carcass 66 and tread 72. The code 12 could be positioned on the track 10 such that wear of the tread 72 does not cause any destruction of the code 12, or wear on the tread 72 may destroy some of the code 12 but the code 12 could still be readable by the cell phone 38 to execute the method.

It is to be understood that the method utilized herein can be used with any track 10 from any manufacturer, and can be used with any vehicle in accordance with other embodiments. The same steps described in the FIGS. 3 and 4 embodiments with a barcode 12 can be employed in the FIGS. 5 and 6 embodiments with the barcode 12 substituted with the two-dimensional code 12 in order to determine the wear of the tread 72, and it is thus not necessary to repeat all of these steps in order to describe how the method may function when a two-dimensional code 12 is used as the code 12 instead of a barcode 12 as the code 12.

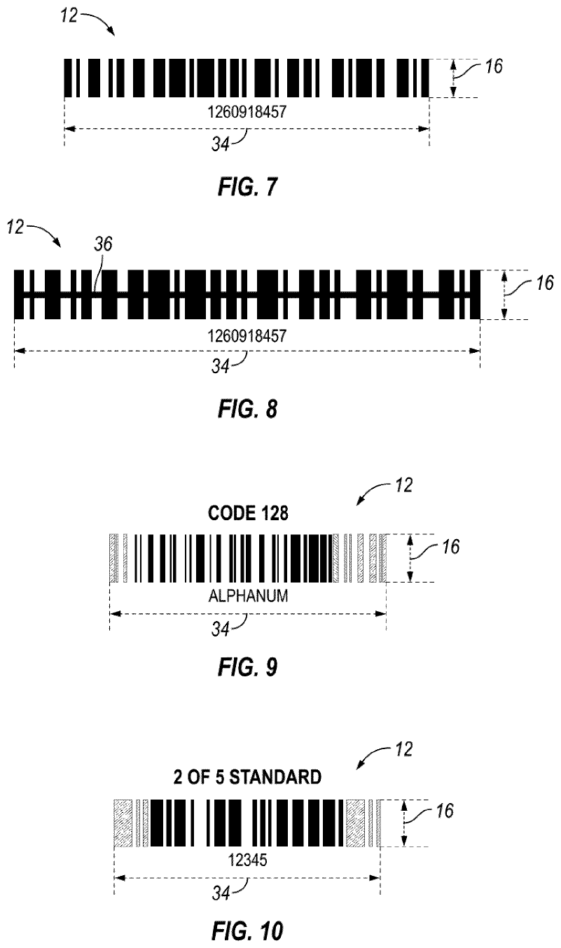

The code 12 that is used can be either a barcode 12 or a two-dimensional code 12. When provided as a barcode 12, the barcode 12 can be one of many different types of barcodes 12. FIG. 7 is a front view of a barcode 12 in accordance with one exemplary embodiment and can be a standard barcode known in the industry that includes data that is embodied in a visual, machine-readable form. The barcode 12 has lines that are parallel to one another and vary in widths, spacing and sizes and are sometimes referred to as linear or one-dimensional codes. The barcode 12 may thus be a one-dimensional object code and not a two-dimensional object code. Information that is read from the barcode 12 is read in a linear manner from one side to the other and is not read in two linear manners that are perpendicular to one another. The barcode 12 has a longitudinal length 34 that is longer than a length 16 that is oriented in the thickness direction 46. However, in other embodiments the length 16 could be longer than the longitudinal length 34. The length 34 is referred to as the longitudinal length 34 because it extends longer in the longitudinal direction 48 than in the thickness direction 46. The barcode 12 may be oriented on the track 10 in any manner such that the bars of the barcode 12 extend generally in the thickness direction 46, generally in the longitudinal direction 48, or generally at a non-zero angle to both the thickness and longitudinal directions 46, 48. Although described in previous embodiments as using the length 16 to calibrate distances captured in the visual data, the method may instead use a known longitudinal length 34 and the measured longitudinal length 34 to calibrate other measured visual data.

FIG. 8 shows the barcode 12 that includes a position line 36 that is oriented at a 90 degree angle to the bars of the barcode 12 and that extends along the entire longitudinal length 34. The position line 36 is located halfway along the length 16 so that it is at the midpoint of the height of the barcode 12 in the length 16 direction. In other versions, the position line 36 need not be at one half of the height of the barcode 12 in the length 16 direction, and in other embodiments the position line 36 need not extend along the entire longitudinal length 34 but could instead extend along less than the entire longitudinal length 34. The position line 36 is an element of the barcode 12 that is not machine readable to obtain coded information from the barcode 12, but is instead an element of the barcode 12 used to know where the barcode 12 is located relative to another portion of the track 10 such as a bottom of the carcass 66, point 74, or worn tread surface 14.

FIG. 9 is another possible embodiment of the barcode 12 that lacks the position line 36, and is known as a Code 128 barcode that is a high-density linear barcode symbology defined in IS/IEC 15417:2007. This barcode 12 is used for alphanumeric or numeric only applications and can encode all 128 characters of ASCII. This barcode 12 generally results in more compact size compared to other barcodes such as Code 39. The barcode 12 can likewise be provided as that shown in FIG. 10 in which the barcode 12 is known as a 2 of 5 standard, sometimes referred to as an interleaved 2 of 5 (ITF). This barcode 12 is a continuous two-width barcode symbology that encodes digits. The encoding method of the 2 of 5 standard barcode 12 encodes pairs of digits in which the first digit is encoded in the five bars, and the second digit is encoded in the five spaces interleaved within them. Two out of every five bars are wide.

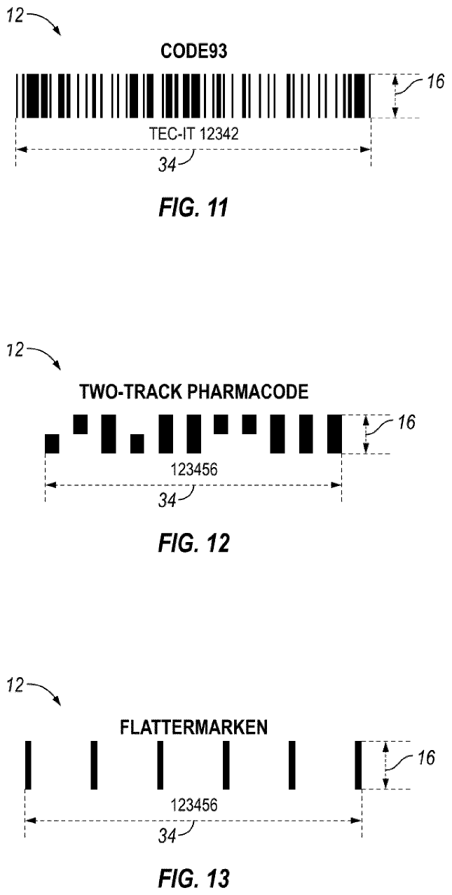

Another barcode 12 that can be used in the present method is shown in FIG. 11 and is known as a Code 93 barcode. The Code 93 barcode is nine modules wide, and has three bars and three spaces. Each bar and space is from one to four modules wide. The Code 93 barcode 12 is designed to encode 26 upper case letters, 10 numerical digits, 7 special characters, and 5 special characters that can be combined with other characters to unambiguously represent all 128 ASCII characters. FIG. 12 shows another possible linear or one-dimensional barcode 12 that can be used in the present method and is known as a two-track pharmacode. The two-track pharmacode is designed to be read by a barcode reader despite printing errors that may occur. This two-track pharmacode barcode 12 uses vertical positioning of half bars together with full bars to encode its data and is designed to be read from right to left.

FIG. 13 shows a barcode 12 that is a flattermarken barcode 12 that is another type of barcode 12 that can be used with the present method. This particular barcode 12 encodes only numerical information and has a character set that is from 0-9. In use, each type of track could be assigned a numerical number, and the barcode 12 can be read to reveal a number that is then cross-referenced with the database to identify the track 10 type and other known information such as lengths 26, 30, 18, 20. The barcodes 12 can be any type of linear barcode that can be read by a cell phone 40 or other machine reader to ascertain either just the type of track 10 that the barcode 12 is located on, or can include additional or alternative information such as the lengths 18, 20, 26 and/or 30. In some embodiments the track 10 type is not identified in the barcode 12, but the barcode 12 contains information in it such as the lengths 18, 20, 26 and/or 30 to determine the wear rate and whether the track 10 needs to be replaced.

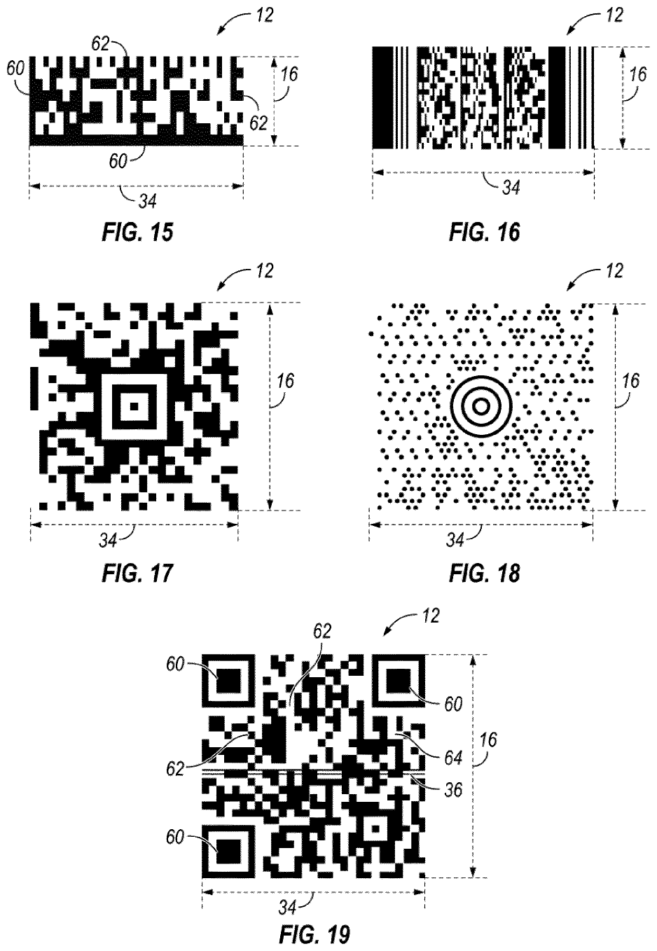

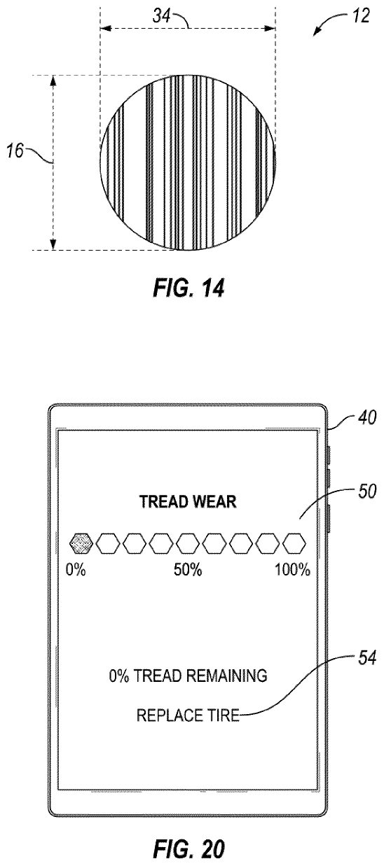

Although described as being rectangular in shape, the barcode 12 need not be rectangular in other embodiments. FIG. 14 shows another embodiment of the barcode 12 in which the barcode 12 is circular in shape instead of being rectangular. In this embodiment, the barcode 12 has a length 16 that is the same distance as the longitudinal length 34. The barcode 12 thus has a single diameter that can be read by the cell phone 40 or other device for calibration purposes to ascertain the length 20. The bars of the barcode 12 can have different heights, or distances in the length 16 direction, and need not all be of the same height. The barcode 12 can have other shapes such as being configured in a triangle, a hexagon, a pentagon, or otherwise.

The various barcodes 12 can be read by a machine in a linear fashion. Some of the barcodes 12 can only be read in a single direction and cannot be read by a machine in more than one direction. Two-dimensional codes 12 can be read by a machine in two different dimensions and need not be limited to a single dimension of reading. Various type of two-dimensional codes 12 can be employed in the present method to ascertain the wear on the tracks 10. FIG. 15 is a front view of a two-dimensional code 12 in accordance with one exemplary embodiment and can be a standard two-dimensional code known in the industry that includes data that is embodied in a visual, machine-readable form. The two-dimensional code 12 has black and white cells arranged in a rectangular pattern, and the encoded data can be text or numeric data. The two-dimensional code 12 is distinguished from a one-dimensional bar code which has information arranged and read in a linear manner from one side to the other and is not read in two linear manners that are perpendicular to one another. The two-dimensional code 12 has a longitudinal length 34 that is longer than a length 16 that is oriented in the thickness direction 46. However, in other embodiments the length 16 could be longer than the longitudinal length 34. The length 34 is referred to as the longitudinal length 34 because it extends longer in the longitudinal direction 48 than in the thickness direction 46. The two-dimensional code 12 may be oriented on the track 10 in any manner such that the cells of the two-dimensional code 12 extend generally in the thickness direction 46, generally in the longitudinal direction 48, or generally at a non-zero angle to both the thickness and longitudinal directions 46, 48. Although described in previous embodiments as using the length 16 to calibrate distances captured in the visual data, the method may instead use a known longitudinal length 34 and the measured longitudinal length 34 to calibrate other measured visual data.

The two-dimensional code 12 shown in FIG. 15 is a type known as a data matrix. Depending upon the particular coding used, a light cell could represent a 0 and a dark cell could represent a 1. The data matrix 12 has a finder pattern 60 that is two solid adjacent boarders that make up an L shape. The finder pattern 60 is used to locate and orient the symbol. The data matrix 12 also includes a timing pattern 62 which are located along the opposite two edges and are alternating cells of light and dark colors. The timing pattern 62 provides a count of the number of rows and columns in the data matrix 12. Within these boarders 60 and 62, there are rows and columns of cells that encode information.

FIG. 16 is another exemplary embodiment of the two-dimensional code 12 that is known as a PDF417 code. A PDF417 code is a stacked linear barcode that has codewords that represent a number from 0 to 928. From left to right in the longitudinal length 34, the PDF417 code has a quiet zone, a start pattern that identifies the two-dimensional code 12 as a PDF417, a row left codeword that contains information about the row, and from 1-30 codewords that represent numbers, letters, or symbols. Moving to the right from the codewords a row right is present that includes more information about the row, a stop pattern, and then another quiet zone. Of the 928 available codewords, 900 can be used for data, and 29 can be used for functions. Information about the track 10 can be stored in the codewords.

FIG. 17 is another example of how the two-dimensional code 12 can be configured. Here, the two-dimensional code 12 is arranged as an Aztec code and is square shaped in that the longitudinal length 34 is the same as the thickness length 16. The Aztec code does not have a quiet zone around its boarders. The Aztec code is configured with a bulls-eye in its center that is used for locating the code. Data on the track 10 is encoded in concentric square rings that surround this central bulls-eye. The corners include orientation marks that allow the data to be read if rotated or reflected. Eight bit values can be encoded with Aztec code, and two escape codes can likewise be present within this particular type of code 12.

A two-dimensional code 12 that can be used in the method is of a type known as a maxicode in FIG. 18. The maxicode is square in shape with the lengths 16 and 34 equal to one another. The maxicode is identified by a bulls-eye in the middle surrounded by a pattern of hexagonal dots. This type of two-dimensional bar code 12 can store up to 93 characters of information. The circular bulls-eye is symmetrical and useful in automatic symbol location regardless of the orientation of the two-dimensional code 12.

FIG. 19 shows the two-dimensional code 12 that may be associated with the method as described with respect to the FIG. 5 or 6 embodiment. The two-dimensional code 12 includes the position line 36 that is oriented at a 90 degree angle and halfway between two of the finder pattern 60 blocks, and the position line 36 extends in the longitudinal direction 48 and is perpendicular to the length 16. The position line 36 is located halfway along the length 16 so that it is at the midpoint of the height of the two-dimensional code 12 in the length 16 direction. In other versions, the position line 36 need not be at one half of the height of the two-dimensional code 12 in the length 16 direction, and in other embodiments the position line 36 need not extend along the entire longitudinal length 34 but could instead extend along less than the entire longitudinal length 34. The position line 36 is an element of the two-dimensional code 12 that is not machine readable to obtain coded information from the two-dimensional code 12, but is instead an element of the two-dimensional code 12 used to know where the two-dimensional code 12 is located relative to another portion of the track 10 such as a point 74 or worn tread surface 14.

The two-dimensional code 12 shown in FIG. 19 is a QR code. The QR code has a quiet zone around its outside, and a finder pattern 60 that is made up of three squares located in the corners of the QR code. Typically, the bottom right corner does not have a square making up part of the finder pattern 60. The finder pattern 60 includes a black square surrounded by a white module that is surrounded by a black module. The finder pattern 60 allows the decoder software to recognize the QR code and determine its correct orientation. A timing pattern 62 is also present within the QR code and can be alternating black and white modules that enable the decoder software to determine the width of a single module. The QR code includes a data area 64 into which data on the track 10 can be stored and read by the system. The QR code shown in FIG. 19 has the position line 36, but it need not be present in other embodiments. The method can locate the length 18 of the position of the two-dimensional code by measuring to the top of the two black modules of the top two finder patterns 60, or by measuring to the bottom of the black module of the bottom finder pattern 60.

Although described as being rectangular or square in shape, the two-dimensional code 12 need not be rectangular or square in other embodiments. The two-dimensional code 12 can be circular in shape. In this embodiment, the two-dimensional code 12 has a length 16 that is the same distance as the longitudinal length 34. The two-dimensional code 12 thus has a single diameter that can be read by the cell phone 40 or other device for calibration purposes to ascertain the length 20. The dots, bars or modules of the two-dimensional code 12 can have different heights, or distances in the length 16 direction, and need not all be of the same height. The two-dimensional code 12 can have other shapes such as being configured in a triangle, a hexagon, a pentagon, or otherwise.

The output from the processing can be provided to the user on the display 50 of a cell phone 40 to inform the user whether the track 10 has tread 72 worn down to replacement level. The display 50 can include various types of information. As shown in FIG. 20, one embodiment of the display 50 may show a graph of percentages of tread wear with cells that are filled up based upon the amount of tread wear remaining after the calculations. The graph can be color coded and can have various configurations. The display 50 may also display a message 54 that tells the user of the percentage of tread 72 remaining and whether the track 10 should or should not be replaced. The message 54 can be variously configured to inform the user of the results of the tread wear determination for knowledge of the state of the track 10.

One example of the method can be shown with reference to FIG. 4 in which the device used in the execution of the method is a cell phone 40 that has a cell phone camera 38 that directs the view 56 onto the track 10 such that the cell phone 40 is oriented in a parallel manner to the side 78. The code 12 is captured in the image 52 and the processor of the cell phone 40 or in the cloud may read the encoded message on the barcode 12 to know the type of track 10. The code 12 here is a barcode 12, but the present example applies as well should the code 12 in FIG. 4 be a two-dimensional code 12. The barcode 12 then identifies known dimensions of the track 10 and physical properties of the barcode 12. In this example, the barcode 12 identifies the particular type of track 10 which can be looked up in a database in the cell phone 40 or cloud upon being read by the cell phone 40. Particular physical properties of the track 10 are then known by the method, and these physical properties are set forth in Table 1 below.

TABLE 1

| | ACTUAL TRACK DIMENSIONS | | | | Replacement |
|---|---|---|---|---|---|
| | Track | Overall | New Tread | Carcass | Tread |
| TRACK | Length | Width | Thickness | Thickness | Thickness |
| TYPE | (mm) | (mm) | (mm) | (mm) | (mm) |
| Agricultural | 6705 | 762 | 40 | 35 | 6 |

The method may or may not use the physical properties listed in Table 1. In the disclosed example the point 74 is at the bottom of the carcass 66 as shown for example in 4. The method may additionally or alternatively use the data shown below in Table 2 in that once the processor identifies the track 10 from the barcode 12 the processor may consult a lookup table to know that the new track 10 new thickness 26 is 75 mm, the replacement thickness 30 is 41 mm, the barcode 12 length 16 is 15 mm, the length 18 of the position of the barcode 12 is 25 mm, and the replacement thickness 30 is 41 mm. The processor and lookup table may be located on the device 40 and/or the cloud.

TABLE 2

| Barcode Length (16) | 15 | mm | Known in Database |
|---|---|---|---|
| Length of Position of | 25 | mm | Known in Database |
| Barcode (18) | | | |
| Length of Worn Tread | 25 | mm | Determined by method |
| Surface to Barcode (20) | | | via measurement |
| Worn Thickness (28) | 50 | mm | Calculated |
| New Thickness (26) | 75 | mm | Known in Database |
| Replacement Thickness (30) | 41 | mm | Known in Database |
| Track Wear Percentage | 73.5% | | Calculated |
| Tread Remaining | 9 | mm | Calculated |

The processor can calculate the worn thickness 28 by taking the visual data obtained from the view 56 to determine the length 20 from the worn tread surface 14 to the barcode 12 which in this case is measured at the most outward position 44. The method will determine this length 20 through knowing the size of the barcode length 16 that is 15 mm, for instance by knowing the amount of pixels in the barcode length 16 and then comparing the amount of pixels within the length 20. This length 20 is determined to be 25 mm. Once the length 20 is determined this length can be added to the length 18 to calculate the worn thickness 28. The length 28 can be calculated as 25 mm+25 mm=50 mm.

At this point, the track wear percentage can be calculated as ((new thickness 26−worn thickness 28)/(new thickness 26−replacement thickness 30)×100. Using the data from Table 2 causes the track wear percentage to be calculated as ((75 mm-50 mm)/(75 mm-41 mm)×100=(25 mm/34 mm)×100=73.5%. This track wear percentage can be provided to the user in the message 54 or otherwise presented on the display 50. This wear percentage can be converted to a tread remaining percentage simply by taking 100%-track wear percentage=100%-73.5%=26.5%. The method can provide a warning message 54 to the user once the tread remaining percentage drops to a certain level, such as 10% or 15%, to inform the user that the track 10 is getting close to needing replacement or retreading.

Additional or alternative messages 54 can be provided to the user by the method. Upon calculating the worn thickness 28, the method may simply compare the replacement thickness 30 to the worn thickness 28 and then display the appropriate message. For example if from Table 2 the worn thickness 28 is 50 mm and is greater than the replacement thickness 30 which is 41 mm, then a sufficient tread level message 54 can be communicated to the user. Further, or alternatively, the remaining tread 72 on the track 10 can be communicated to the user in the message 54. The remaining tread can be calculated by taking the worn thickness 28−the replacement thickness 30. Using the Table 2 data, the remaining tread 72=(50 mm-41 mm)=9 mm. It is to be understood that various ways of calculating the aforementioned properties of the track 10 are possible and that those disclosed are only exemplary.

Measured data combined with date and location information provided by the device and software may be processed under the form of track 10 wear speed in time for specific locations and used for prediction of track 10 wear in the future. For example, multiple measurements may be taken at certain time intervals to create a curve that projects into the future the estimation of time when the track 10 will be worn to the replacement thickness 30. Measurements to obtain data points and projecting this information onto a graph over time not only provides insight onto the current wear status of the track 10, but further allows one to better predict the date when the track 10 will reach its end of life.

When the code 12 is configured as a barcode 12, the barcode 12 can be machine readable only in a linear direction, and cannot be readable in a two-dimensional direction. However, the calibration for the objects in the image 52 can be made using either one dimensional or two-dimensional measurements of known and observed lengths of the barcode 12. When the code 12 is a two-dimensional code 12, it can be machine readable in two different directions. Again, the calibration for the objects in the image 52 can be made using either one or two-dimensional measurements of known and observed lengths of the two-dimensional code 12. The method can be organized so that every individual track 10 is individually identified by the barcode 12 or two-dimensional code 12, or can be organized so that the barcode/two-dimensional code 12 identifies physical dimensions of the track 10 but does not distinguish between the track 10 and another track 10 that shares the same physical dimensions and thus does not uniquely identify the track 10.

Although described as using a known length 16 in the thickness direction 46 to calibrate the method into determining the length 20 upon capturing the image 52, this need not be done in other embodiments. For example, the longitudinal length 34 could be known by the system and then measured in the captured image 52 to in turn calibrate the method to know the measured length 20 in the thickness direction 46. Any known dimension or combination of known dimensions of the code 12 can be used for calibration purposes to establish the length 20. A known length that runs in both the longitudinal direction 48 and thickness direction 46 of the code 12 can be used for calibration purposes in other embodiments. The code 12 thus provides information content to the method, and provides the method with a size and known positioning on the track 10 to effect the measurement in the method. The code 12 content can provide information about the type of track 10 that will be used by the application to process measurement data and compare it to the known track 10 specifications. The size of the code 12, either the length 16, longitudinal length 34, or combinations thereof provides a calibrated reference for the camera measuring algorithm.

The method disclosed herein can be used to measure tread 72 wear on any type of track 10 and the various types of tracks 10 disclosed herein are only exemplary and others are possible. When described as measuring “wear” on the track 10 or on the tread 72 it is to be understood that these two terms are interchangeable with one another as used herein. Thus wear of the track 10 is the same as wear of the tread 72 as described herein with reference to the present measurement method.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A method of measuring a track, comprising:
providing a track that has a carcass and tread, wherein the track has a ground-engaging outer surface and an oppositely disposed inner surface, and wherein the track is disposed around a track-engaging assembly that is configured for moving the track around the track-engaging assembly, wherein the tread has a worn tread surface, wherein the track has a longitudinal direction and a thickness direction;
providing a code on the track that is spaced from the worn tread surface in the thickness direction;
obtaining visual data from the track and the code;
obtaining from the code a track type;
determining from the visual data a length of the code that extends in the thickness direction;
determining from the visual data a length of a position of the code that extends in the thickness direction, wherein the length of the position of the code is measured in the thickness direction from a point, wherein the code is located between the point and the worn tread surface in the thickness direction;
determining a worn tread surface to code length in the thickness direction from the visual data using the length of the code; and
calculating a worn thickness in the thickness direction by adding the length of the position of the code to the worn tread surface to code length.

2. The method as set forth in claim 1, wherein the code is located on a side of the carcass, and wherein the point is located at a bottom location of the side of the carcass in the thickness direction.

3. The method as set forth in claim 1 or 2, wherein the track-engaging assembly has a wheel that has a central axis and that has wheel tread, wherein the wheel tread engages the inner surface of the track, wherein the track has drive lugs, wherein the point is located radially outward from the wheel tread.

4. The method as set forth in claim 1, wherein the code is a barcode.

5. The method as set forth in claim 1, wherein the code is a two-dimensional code.

6. A method of measuring a track, comprising:
providing a track that has a carcass and tread, wherein the track has a ground-engaging outer surface and an oppositely disposed inner surface, and wherein the track is disposed around a track-engaging assembly that is configured for moving the track around the track-engaging assembly, wherein the tread has a worn tread surface, wherein the track has a longitudinal direction and a thickness direction;
providing a code on the track that is spaced from the worn tread surface in the thickness direction;
obtaining visual data from the track and the code;
determining from the visual data a length of the code that extends in the thickness direction;
determining from the visual data a length of a position of the code that extends in the thickness direction, wherein the length of the position of the code is measured in the thickness direction from a point, wherein the code is located between the point and the worn tread surface in the thickness direction;
determining a worn tread surface to code length in the thickness direction from the visual data using the length of the code; and
calculating a worn thickness in the thickness direction by adding the length of the position of the code to the worn tread surface to code length;
wherein the visual data obtained from the code causes determining of a new thickness and a replacement thickness by lookup from a database;
further comprising calculating a wear rate of the tread by the following equation:
$$the tread wear rate = ( \frac{( the new thickness - the worn thickness )}{( the new thickness - the replacement thickness )} ) \times 100.$$

7. The method as set forth in claim 1, wherein the visual data obtained from the code causes determining of the length of the code and the length of the position of the code by lookup from a database.

8. A method of measuring a track, comprising:
providing a track that has a carcass and tread, wherein the track has a ground-engaging outer surface and an oppositely disposed inner surface, and wherein the track is disposed around a track-engaging assembly that is configured for moving the track around the track-engaging assembly, wherein the tread has a worn tread surface, wherein the track has a longitudinal direction and a thickness direction;
providing a code on the track that is spaced from the worn tread surface in the thickness direction;
obtaining visual data from the track and the code;
determining from the visual data a length of the code that extends in the thickness direction;
determining from the visual data a length of a position of the code that extends in the thickness direction, wherein the length of the position of the code is measured in the thickness direction from a point, wherein the code is located between the point and the worn tread surface in the thickness direction;
determining a worn tread surface to code length in the thickness direction from the visual data using the length of the code; and
calculating a worn thickness in the thickness direction by adding the length of the position of the code to the worn tread surface to code length;
wherein the visual data obtained from the code causes determining of a new thickness and a replacement thickness from a database, and further comprising determining wear of the track by comparing the worn thickness to the new thickness and the replacement thickness.

9. The method as set forth in claim 4, wherein the code has a position line that is oriented perpendicular to lines of the code, wherein the position line is used in determining from the visual data the length of the position of the code.

10. The method as set forth in claim 5, wherein the code is a data matrix, wherein the data matrix has a finder pattern along two edges of the data matrix, and wherein the data matrix has a timing pattern along two edges of the data matrix that do not include the finder pattern.

11. The method as set forth in claim 5, wherein the code is a QR code, wherein the QR code has three squares that make up a finder pattern, wherein the QR code has a data area.

12. The method as set forth in claim 1, wherein the obtaining visual data from the track and the code is from use of a visual data capture device that is a cell phone camera.

13. The method as set forth in claim 1, wherein the length of the position of the code is measured to a position of the code closest to the tread in the thickness direction.

14. The method as set forth in claim 1, further comprising:
evaluating wear of the tread by comparing the worn thickness to a replacement thickness, wherein the replacement thickness is obtained via lookup from a database;
reporting that the track does not need replacement if the worn thickness is greater than the replacement thickness;
reporting that the track needs replacement if the worn thickness is less than the replacement thickness.

15. The method as set forth in claim 1, wherein the track engaging assembly is located on an agricultural tractor vehicle.
